(19) United States
(12) Patent Application Publication
(10) Pub. No.: US 2013/0225471 A1
(43) Pub. Date: Aug. 29, 2013

(54) COMPOSITION FOR CLEANING AND ARTICLE INCLUDING THE SAME

(71) Applicant: BASF SE, (US)

(72) Inventors: Ashish Taneja, Ann Arbor, MI (US); Simone Bright, Detroit, MI (US); Kenneth L. Zack, Wyandotte, MI (US); Thomas B. Gessner, Ypsilanti, MI (US)

(73) Assignee: BASF SE, Ludwigshafen (DE)

(21) Appl. No.: 13/774,333

(22) Filed: Feb. 22, 2013

Related U.S. Application Data
(60) Provisional application No. 61/602,289, filed on Feb. 23, 2012.

(51) Int. Cl. C11D 1/722; C11D 1/72; C11D 3/48

(52) U.S. Cl. CPC C11D 1/722; C11D 3/48; C11D 1/72
USPC 510/389

(57) ABSTRACT

A composition for cleaning a surface and an article including a substrate and the composition for cleaning the surface are provided herein. The composition comprises a biocide, a first alcohol alkoxylate, an alkyl polyglycoside, a supplemental alcohol alkoxylate, and water. The composition is substantially free of organic solvents and has a cleaning performance of from 30% to 70% as determined in accordance with the Federal Test method Std. No. 536A/GEN, “Soap and Soap-Products (Including Synthetic Detergent)”.

### CROSS REFERENCE TO RELATED APPLICATIONS

This application claims priority to and all the benefits of U.S. Provisional Patent Application Ser. No. 61/602,289, filed on Feb. 23, 2012, the entire specification of which is expressly incorporated herein by reference.

### BACKGROUND OF THE INVENTION

The instant invention generally relates to a composition for cleaning a surface and which comprises a biocide, a first alcohol alkoxylate, an alkyl polyglycoside, a supplemental alcohol alkoxylate, and water. The composition has excellent cleaning performance and is substantially free of volatile organic compounds.

### Description of the Related Art

There are many compositions useful as cleaning compositions. Generally, conventional cleaning compositions include a plurality of ingredients and a carrier and/or solvent. In some instances the carrier and/or solvent includes a volatile organic compound (VOC). A VOC is generally classified for regulatory purposes as any volatile compound of carbon unless specifically exempt.

It is well known that the VOCs generally have an impact on the environment, and more specifically on trioxygen, or ozone. Ozone, as is known, may impact humans differently depending on the location of the ozone in the atmosphere. For example, ozone in the upper atmosphere absorbs ultraviolet radiation therefore protecting earth, and humans, from ultraviolet radiation emitted from the sun. However, ground level ozone, or tropospheric ozone, on the other hand, is a significant component of smog which generally has an adverse effect on human health and may contribute to or inflame a variety of respiratory ailments and/or illnesses.

Generally, ozone is formed and destroyed in the upper atmosphere when UV light from the sun interacts with dioxygen. However, ozone is also formed when UV light reacts with carbon monoxide (CO), oxides of nitrogen (NOx), and VOCs. VOCs generally shift the overall equilibrium between ozone and NOx resulting in the accumulation of ozone. While there are natural contributors to VOCs, man-made sources such as vehicle emissions, petroleum refining, and combustion also contribute to VOC levels. Another specific source of VOCs is organic solvents, such as those organic solvents found in various compositions, including some cleaning compositions.

The Clean Air Act (CAA) sets national standards for ground level ozone. Those areas of the country which do not meet the national standards are referred to as “ozone non-attainment areas” and are generally required to reduce VOC emissions by 3% each year, not including vehicle emissions, until the national standard is met. Accordingly, for the ozone non-attainment areas to achieve the national standards set by the CAA and reach ground-level ozone attainment levels, sources of man-made emissions of VOCs should be regulated, including use of organic solvents, such as those included in cleaning compositions.

Despite efforts to develop cleaning compositions substantially free of organic solvents, such cleaning compositions may perform poorly as compared to other industry benchmark cleaning compositions such as Clorox® Disinfecting Wipes, Pledge® Multisurface Wipes, and Meijer® Surface and Glass Wipes. Improvements in compositions, such as cleaning compositions, which are substantially free of organic solvents and other VOCs could lead to reduction of VOCs in the atmosphere and provide “ozone non-attainment areas” another tool for compliance with the national standards for ground level ozone set by the CAA. Accordingly, there remains an opportunity to form an improved composition free of organic solvents having excellent cleaning performance.

### SUMMARY OF THE INVENTION AND ADVANTAGES

The instant invention provides a composition for cleaning a surface and an article including a substrate and the composition for cleaning the surface. The composition comprises a biocide, a first alcohol alkoxylated, an alkyl polyglycoside, a supplemental alcohol alkoxylate, and water. The first alcohol alkoxylate has the general formula (II):

R—O-(A)_{b}H (II)

wherein R is a hydrocarbon group having from 10 to 20, each A is independently selected from alkyleneoxy groups having from 2 to 4 carbon atoms, and b has a value of from 5 to 15. Each of the biocide, the first alcohol alkoxylate, and the alkyl polyglycoside, and the supplemental alcohol alkoxylate are individually present in the composition in an amount of greater than 0% and less than 2% by weight based on the total weight of the composition. The balance of the composition comprises water which is present in the composition in an amount of at least 92% and less than 100% by weight based on the total weight of the composition. The composition is substantially free of volatile organic compounds and has a cleaning performance of from 30% to 70% as determined in accordance with the Federal Test method Std. No. 536A/GEN, “Soap and Soap-Products (Including Synthetic Detergents)”.

The composition of the instant invention exhibits excellent cleaning performance. In fact, the performance of the composition is comparable to, and in some instances superior than, cleaning performance achieved when using benchmark cleaning compositions included in Clorox® Disinfecting Wipes, Pledge® Multisurface Wipes, and Meijer® Surface and Glass Wipes.

### DETAILED DESCRIPTION OF THE INVENTION

A composition for cleaning a surface and an article including the composition for cleaning the surface are provided herein. The composition includes a biocide, a first alcohol alkoxylate, an alkyl polyglycoside, a supplemental alcohol alkoxylate, and water. Additionally, the composition is substantially free of volatile organic compounds including, but not limited to, organic solvents.

The terminology “substantially free”, as used herein in reference to volatile organic compounds, refers to a sufficiently low amount of volatile organic compounds. Typically, the amount of volatile organic compounds that are present in the composition is less than 5, alternatively less than 4, alternatively less than 3, alternatively less than 2, alternatively less than 1, alternatively less than 0.5, and alternatively less than 0.1, percent by weight based on the total weight of the composition.

Typically, the biocide has the general formula (I):

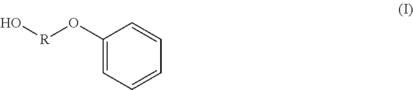

In the general formula of the biocide, R is a hydrocarbon group having from 1 to 4 carbon atoms. Typically, R is a hydrocarbon group having 2 carbon atoms. Suitable examples of commercially available biocides include, but are not limited to Protectol® products commercially available from BASF Corp. In one embodiment, the biocide is Protectol® PE. Typically, the biocide is present in an amount of greater than 0% and less than 2% by weight, alternatively from 0.1% to 2% by weight, alternatively from 0.1% to 1% by weight, alternatively from 0.4% to 0.6% be weight, based on the total weight of the composition.

The first alcohol alkoxylate has the general formula (II):

R¹—O-(A)_{b}H (II)

In the general formula of the first alcohol alkoxylate, R¹ is a hydrocarbon group having from 10 to 20, alternatively from 10 to 15, and alternatively 13 carbon atoms. As is known in the art, hydrocarbon groups may include straight, branched, and/or cyclic chains of carbon and hydrogen atoms which may be saturated or unsaturated. However, the hydrocarbon group is typically a straight chain hydrocarbon group. Additionally, A in the general formula for the first alcohol alkoxylate is an alkyleneoxy group having from 2 to 4 carbon atoms. Suitable alkyleneoxy groups include ethyleneoxy groups (2 carbon atoms), propyleneoxy groups (3 carbon atoms), butyleneoxy groups (4 carbon atoms), and combinations thereof. Typically, A is an ethyleneoxy group. Ethyleneoxy groups are typically present in an amount at least 90%, more typically at least 95%, and most typically at least 99% of all alkyleneoxy groups present in the first alcohol alkoxylate. The variable b represents a number of alkyleneoxy groups present in the first alcohol alkoxylate and has a value of from 5 to 15, alternatively from 7 to 11, and alternatively from 8 to 10. Suitable examples of commercially available alcohol alkoxylates include, but are not limited to Lutensol® TDA products commercially available from BASF Corp. In one embodiment, the first alcohol alkoxylate is Lutensol® TDA 9. The first alcohol alkoxylate is typically present in the composition in an amount of greater than 0% and less than 2% by weight, alternatively from 0.1% to 2% by weight, alternatively from 0.1% to 1% by weight, and alternatively from 0.2% to 0.6% by weight, based on the total weight of the composition.

In one embodiment, the first alcohol alkoxylate is produced by alkoxylating a first alcohol having from 10 to 20 carbon atoms with an alkylene oxide in the presence of a catalyst and water. The first alcohol may include any alcohol having from 10 to 20 carbon atoms. In one embodiment the first alcohol includes a mixture of different alcohols independently having from 10 to 20 carbon atoms. Alternatively, the first alcohol may include a single type of alcohol having from 10 to 20 carbon atoms. In one embodiment, the first alcohol is a tridecyl alcohol.

The alkyl polyglycoside typically has the general formula (III):

(D)-OR² (III)

wherein D is a glycosyl group and R² is a hydrocarbon group having from 5 to 20 carbon atoms and alternatively 8 to 16 carbon atoms. In one embodiment, D has a degree of polymerization of from 1 to 3 and alternatively from 1.3 to 1.8. The hydrocarbon group may include straight, branched, and/or cyclic chains of carbon and hydrogen atoms which may be saturated or unsaturated. However, the hydrocarbon group is typically a straight chain hydrocarbon group. It is to be appreciated that the alkyl polyglycoside may include a mixture of alkyl polyglycosides that individually include a hydrocarbon group with 8, 10, 12, 14, or 16 carbon atoms. In one embodiment, the alkyl polyglycoside has an average hydrocarbon group chain length of from 8 to 12 carbon atoms and alternatively from 10 to 10.5 carbon atoms. Suitable examples of commercially available alkyl polyglycosides include, but are not limited to Glucopon™ products commercially available from BASF Corp. In one embodiment, the alkyl polyglycoside is Glucopon® 425N. The alkyl polyglycoside is typically present in an amount of greater than 0% and less than 2% by weight, alternatively from 0.1% to 2% by weight, alternatively from 0.1 to 1% by weight, alternatively from 0.5% to 1% by weight, and alternatively from 0.7% to 0.9% by weight, based on the total weight of the composition.

In one embodiment, the alkyl polyglycoside is produced by reacting a monosaccharide, or a compound hydrolysable to a monosaccharide, with an alcohol such as a fatty alcohol in an acid medium.

The composition includes a supplemental alcohol alkoxylate. Typically, the supplemental alcohol alkoxylate is selected from the group of carboxylated alcohol alkoxylates, a first supplemental alcohol alkoxylate, a second supplemental alcohol alkoxylate, a third supplemental alcohol alkoxylate, a fourth supplemental alcohol alkoxylate, and combinations thereof. In one embodiment, the supplemental alcohol alkoxylate includes a carboxylated alcohol alkoxylate.

The carboxylated alcohol alkoxylate typically has the general formula (IV):

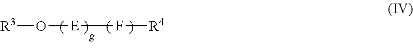

wherein R³ is hydrocarbon group having from 6 to 14 carbon atoms; R⁴ is selected from the group of a hydrogen atom, an alkyl group, and an aryl group; each E is independently selected from an alkyleneoxy group having from 2 to 4 carbon atoms; g is of from 12 to 25; and F is of the general formula (V):

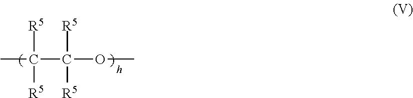

wherein each R⁵ is independently selected from the group of a hydrogen atom, a methyl group, and a salt of a carboxyl group; and h is of from 13 to 20. In one embodiment, at least one R⁵ is a salt of a carboxyl group. Typically, the carboxyl group is further defined as a dicarboxyl group.

In another embodiment, the carboxylated alcohol alkoxylate is of the general formula (VI):

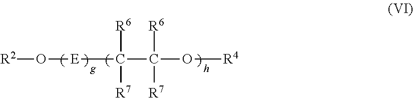

wherein R³, R⁴, E, g, and h are the same as described above; each R⁶ is independently selected from the group of a hydrogen atom and a methyl group; and each R⁷ is independently selected from the group of a hydrogen atom and a salt of a dicarboxyl group of the general formula (VII):

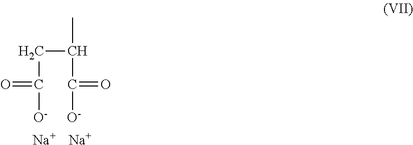

so long as at least one R⁷ is represented by the salt of the dicarboxyl group of the general formula (VII). In one embodiment, g is from 15 to 19. In another embodiment, h is from 15 to 19. Suitable examples of commercially available carboxylated alcohol alkoxylates include, but are not limited to Plurafac® CS products commercially available from BASF Corp. In one embodiment, the carboxylated alcohol alkoxylate is Plurafac® CS-1. The carboxylated alcohol alkoxylate is typically present in an amount of greater than 0% and less than 2% by weight, alternatively from 0.1% to 2% by weight, alternatively from 0.1% to 1% by weight, alternatively from 0.1% to 0.5% by weight, and alternatively from 0.2% to 0.3% by weight, based on the total weight of the composition.

In another embodiment, the supplemental alcohol alkoxylate includes the first supplemental alcohol alkoxylate having the general formula (VIII):

R⁸—O—(I)ⱼH (VIII)

In the general formula of the first supplemental alcohol alkoxylate, R⁸ is a hydrocarbon group having from 6 to 14 carbon atoms. It is contemplated that the hydrocarbon group having from 6 to 14 carbon atoms may be branched, and may particularly be formed from a Guerbet alcohol as described below. In one embodiment, R⁸ is a hydrocarbon group having 10 carbon atoms. An example of a suitable hydrocarbon group having 10 carbon atoms includes, but is not limited to, a 2-propylheptane moiety. It is to be understood that the terminology “2-propylheptane moiety” refers to a C₁₀H₂₂ moiety bonded to the oxygen atom in the general formula of the first supplemental alcohol alkoxylate. For descriptive purposes only, a chemical structure of the 2-propylheptane moiety is shown below:

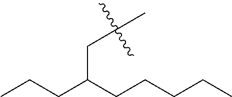

Additionally, I in the general formula for the first supplemental alcohol alkoxylate is an alkyleneoxy group having from 2 to 4 carbon atoms. Typically, I is further defined as an ethyleneoxy group. Further, the variable j represents a number of alkyleneoxy groups present in the first supplemental alcohol alkoxylate and has a value of from 3 to 20, alternatively from 5 to 15, alternatively from 5 to 10, alternatively from 6 to 8. It is contemplated that, when a combination of different alkyleneoxy groups is present in the first supplemental alcohol alkoxylate, the alkyleneoxy groups may be distributed randomly or blockwise. Suitable examples of commercially available alcohol alkoxylates include, but are not limited to Lutensol® XL products commercially available from BASF Corp. In one embodiment, the first supplemental alcohol alkoxylate is Lutensol® XL 70. The first supplemental alcohol alkoxylate is preferably present in the composition in an amount of greater than 0% and less than 2% by weight, alternatively from 0.1% to 2% by weight, alternatively from 0.1% to 1% by weight, and alternatively from 0.2% to 0.3% by weight, based on the total weight of the composition.

In one embodiment, the first supplemental alcohol alkoxylate may be produced in a similar manner in which the first alcohol alkoxylate is produced, i.e., by alkoxylating a second alcohol having from 6 to 14 carbon atoms with an alkylene oxide in the presence of a catalyst and water.

The second alcohol may include any alcohol having from 6 to 14 carbon atoms. In one embodiment, the second alcohol includes a mixture of different alcohols independently having from 6 to 14 carbon atoms. Alternatively, the second alcohol may include a single type of alcohol having from 6 to 14 carbon atoms. As alluded to above, the second alcohol can be a Guerbet alcohol. Preferably, the second alcohol has 10 carbon atoms and includes 2-propylheptanol. For descriptive purposes only, a chemical structure of 2-propylheptanol is shown below:

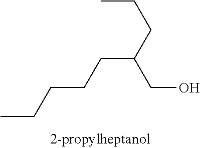

Typically, the step of alkoxylating the first alcohol is completed separately from the step of alkoxylating the second alcohol. Process conditions for producing alcohol alkoxylates are generally known in the art.

In another embodiment, the supplemental alcohol alkoxylate includes the second supplemental alcohol alkoxylate having the general formula (XI):

R⁹—O—(K)₁H (XI)

In the general formula of the second supplemental alcohol alkoxylate, R⁹ is a hydrocarbon group having from 2 to 10 and alternatively from 4 to 8 carbon atoms. The hydrocarbon groups may include straight, branched, and/or cyclic chains of carbon and hydrogen atoms which may be saturated or unsaturated. However, the hydrocarbon group is typically a straight chain hydrocarbon group. Additionally, K in the general formula for the second supplemental alcohol alkoxylate is an alkyleneoxy group having from 2 to 4 carbon atoms. Suitable alkyleneoxy groups include ethyleneoxy groups (2 carbon atoms), propyleneoxy groups (3 carbon atoms), butyleneoxy groups (4 carbon atoms), and combinations thereof. Typically, K is an ethyleneoxy group. Ethyleneoxy groups are typically present in an amount at least 90%, more typically at least 95%, and most typically at least 99% of all alkyleneoxy groups present in the second supplemental alcohol alkoxylate. The variable 1 represents a number of alkyleneoxy groups present in the second supplemental alcohol alkoxylate and has a value of from 2 to 10, alternatively from 3 to 7, and alternatively 5. Suitable examples of commercially available alcohol alkoxylates include, but are not limited to Emulan® products commercially available from BASF Corp. In one embodiment, the second supplemental alcohol alkoxylate is Emulan® HE 50. The second supplemental alcohol alkoxylate is typically present in the composition in an amount of greater than 0% and less than 2% by weight, alternatively from 0.1% to 2% by weight, alternatively from 0.1% to 1% by weight, and alternatively from 0.2% to 0.3% by weight, based on the total weight of the composition.

In one embodiment, the second supplemental alcohol alkoxylate is produced by alkoxylating a third alcohol having from 2 to 10 carbon atoms with an alkylene oxide in the presence of a catalyst and water. The third alcohol may include any alcohol having from 2 to 10 carbon atoms. In one embodiment the third alcohol includes a mixture of different alcohols independently having from 2 to 10 carbon atoms. Alternatively, the third alcohol may include a single type of alcohol having from 2 to 10 carbon atoms.

In yet another embodiment, the supplemental alcohol alkoxylate includes the third supplemental alcohol alkoxylate having the general formula (X):

R¹⁰—O-(M)ₙH (X)

In the general formula of the third supplemental alcohol alkoxylate, R¹⁰ is a hydrocarbon group having from 5 to 30 and alternatively from 8 to 22 carbon atoms. As is known in the art, hydrocarbon groups may include straight, branched, and/or cyclic chains of carbon and hydrogen atoms which may be saturated or unsaturated. However, the hydrocarbon group is typically a straight chain hydrocarbon group. Additionally, M in the general formula for the third supplemental alcohol alkoxylate is an alkyleneoxy group having from 2 to 4 carbon atoms. Suitable alkyleneoxy groups include ethyleneoxy groups (2 carbon atoms), propyleneoxy groups (3 carbon atoms), butyleneoxy groups (4 carbon atoms), and combinations thereof. Typically, M is a combination of alkyleneoxy groups. However, ethyleneoxy groups are typically present in an amount at least 40%, alternatively at least 60%, and alternatively at least 70% of all alkyleneoxy groups present in the third supplemental alcohol alkoxylate. The variable n represents a number of alkyleneoxy groups present in the third supplemental alcohol alkoxylate and has a value of from 1 to 10, alternatively from 3 to 9, and alternatively from 5 to 7. Suitable examples of commercially available alcohol alkoxylates include, but are not limited to Plurafac® LF products commercially available from BASF Corp. In one embodiment, the third supplemental alcohol alkoxylate is Plurafac® LF-1200. The third supplemental alcohol alkoxylate is typically present in the composition in an amount of greater than 0% and less than 2% by weight, alternatively from 0.1% to 2% by weight, alternatively from 0.1% to 1% by weight, and alternatively from 0.4% to 0.6% by weight, based on the total weight of the composition.

In one embodiment, the third supplemental alcohol alkoxylate is produced by alkoxylating a fourth alcohol having from 8 to 22 carbon atoms with an alkylene oxide in the presence of a catalyst and water. The fourth alcohol may include any alcohol having from 8 to 22 carbon atoms. In one embodiment the fourth alcohol includes a mixture of different alcohols independently having from 8 to 22 carbon atoms. Alternatively, the fourth alcohol may include a single type of alcohol having from 8 to 22 carbon atoms.

In still yet another embodiment, the supplemental alcohol alkoxylate includes the fourth supplemental alcohol alkoxylate having the general formula (XI):

R¹¹—O—(P)_{q}H (XI)

In the general formula of the fourth supplemental alcohol alkoxylate, R¹¹ is a hydrocarbon group having from 5 to 20 and alternatively from 10 to 18 carbon atoms. The hydrocarbon groups may include straight, branched, and/or cyclic chains of carbon and hydrogen atoms which may be saturated or unsaturated. However, the hydrocarbon group is typically a straight chain hydrocarbon group. Additionally, P in the general formula for the fourth supplemental alcohol alkoxylate is an alkyleneoxy group having from 2 to 4 carbon atoms. Suitable alkyleneoxy groups include ethyleneoxy groups (2 carbon atoms), propyleneoxy groups (3 carbon atoms), butyleneoxy groups (4 carbon atoms), and combinations thereof. Typically, P is a combination of ethyleneoxy groups and propyleneoxy groups. Ethyleneoxy groups are typically present in an amount at least 25%, alternatively at least 50%, and alternatively at least 90% of all alkyleneoxy groups present in the third supplemental alcohol alkoxylate. The variable q represents a number of alkyleneoxy groups present in the fourth supplemental alcohol alkoxylate and has a value of from 2 to 18, alternatively from 5 to 15, and alternatively from 7 to 11. Suitable examples of commercially available alcohol alkoxylates include, but are not limited to Plurafac® RA products commercially available from BASF Corp. In one embodiment, the third supplemental alcohol alkoxylate is Plurafac® RA30. The fourth supplemental alcohol alkoxylate is typically present in the composition in an amount of greater than 0% and less than 2% by weight, alternatively from 0.1% to 2% by weight, alternatively from 0.1% to 1% by weight, and alternatively from 0.2% to 0.3% by weight, based on the total weight of the composition.

In one embodiment, the fourth supplemental alcohol alkoxylate is produced by alkoxylating a fifth alcohol having from 5 to 20 carbon atoms with an alkylene oxide in the presence of a catalyst and water. The fifth alcohol may include any alcohol having from 5 to 20 carbon atoms. In one embodiment the fifth alcohol includes a mixture of different alcohols independently having from 5 to 20 carbon atoms. Alternatively, the fifth alcohol may include a single type of alcohol having from 5 to 20 carbon atoms.

In one embodiment, the supplemental alcohol alkoxylate of the composition includes the carboxylated alcohol alkoxylate and at least one of the first, second, third, and/or fourth supplemental alcohol alkoxylates described above. Alternatively, the supplemental alcohol alkoyxlate of the composition includes the carboxylated alcohol alkoxylate and the first supplemental alcohol alkoxylate described above. Alternatively, the supplemental alcohol alkoxylate of the composition includes the carboxylated alcohol alkoxylate, the first supplemental alcohol alkoxylate, the second supplemental alcohol alkoxylate, and the third supplemental alcohol alkoxylate. Alternatively, the supplemental alcohol alkoxylate of the composition includes the carboxylated alcohol alkoxylate, the second supplemental alcohol alkoxylate, and the fourth supplemental alcohol alkoxylate. Alternatively, the supplemental alcohol alkoxylate of the composition includes the carboxylated alcohol alkoxylate, the third supplemental alcohol alkoxylate, and the fourth supplemental alcohol alkoxylate. Alternatively, the supplemental alcohol alkoxylate of the composition includes the first supplemental alcohol alkoxylate and at least one of the second, third, or fourth supplemental alcohol alkoxylates. Alternatively, the supplemental alcohol alkoxylate of the composition includes the first supplemental alcohol alkoxylate and the fourth supplemental alcohol alkoxylate. Alternatively, the supplemental alcohol alkoxyalate of the composition includes each of the first, second, third, and fourth supplemental alcohol alkoxylates.

The composition also includes water. Typically water is present in an amount of at least 90% and less than 100% by weight, alternatively at least 92% and less than 100% by weight, alternatively at least 95% and less than 100% by weight, alternatively at least 97% and less than 100% by weight, and alternatively at least 98% and less than 100% by weight, based on the total weight of the composition.

The composition can also include additional additives other than the components described above. For example, the composition may include wetting agents, surfactants, emulsifiers, antifoams, anti-settling agents, additional biocides, and combinations of the aforementioned additives. However, it is to be appreciated that these additional additives are optional. Typically, the additional additives are present in an amount of up to 1 percent by weight and alternatively up to 0.01 percent by weight, based on the total weight of the composition.

The composition has excellent cleaning properties and is suitable for use as a cleaning composition. More specifically, the composition may be used for cleaning, disinfecting, and/or sanitizing household surfaces, including floors, counter tops, sinks, tubs, showers, furniture, windows, and walls. The composition may also be used for cleaning the interior and/or exterior of vehicles. Typically, the composition has a cleaning performance of from 30 to 70, alternatively from 30 to 60, alternatively from 35 to 55, alternatively from 40 to 60, alternatively from 45 to 60, alternatively from 45 to 55, and alternatively from 50 to 60, as determined in accordance with the Federal Test method Std. No. 536A/GEN, “Soap and Soap-Products (Including Synthetic Detergent. Additionally, the composition performs as well as, or better, than industry benchmark including Clorox® Disinfecting Wipes, Pledge® Multisurface Wipes, and Meijer® Surface and Glass Wipes, as determined through cleaning tests that are described in detail below.

Notably, the composition is substantially film free. Stated differently, applying the composition to a surface for cleaning will not result in substantial film formation/deposition on the surface. In one embodiment, at least 92% of the composition by weight, alternatively at least 94% of the composition by weight, alternatively at least 96% of the composition by weight, alternatively at least 97% of the composition by weight, and alternatively at least 98% of the composition by weight, based on the total weight of the composition applied to a surface will evaporate from the surface. Also, because the composition and does not include organic solvents, or significant amounts of organic solvents, which contribute to smog formation, the composition is safe for humans to use as a cleaning composition.

Without being bound to any particular theory, it is believed that the combinations of the components described above, in the amounts described above, increases cleaning performance of the composition.

Method of Preparing the Composition

One method of preparing the composition in accordance with the instant invention includes the step of combining the biocide, the first alcohol alkoxylate, the alkyl polyglycoside, the supplemental alcohol, and water. Typically, these components are combined in a vessel to form the composition. In one embodiment, the step of combining may further include combining additional additives to form the composition. The biocide, the first alcohol alkoxylate, the alkyl polyglycoside, the supplemental alcohol alkoxylate, water, and additional additives may be combined in any order. Typically, the components are combined at 25° C. The vessel may be a mixing vessel or alternatively include a mixing device as known in the art.

Article Including the Composition

As introduced above, an article is provided that includes a substrate and the composition as described above. Typically, the substrate includes at least one layer. In one embodiment, the substrate includes more than one layer. The substrate may include any suitable material that can be combined with the composition for cleaning purposes. Suitable examples of substrates include, but are not limited to, natural materials, synthetic materials, adsorbent materials, woven materials, non-woven materials, and any other material that can be employed to clean a hard and/or soft surface by physical contact, e.g., wiping, scrubbing, buffing, polishing, and the like. In one embodiment, the substrate includes a non-woven material, i.e., a material formed without the aid of a textile weaving or knitting process. Suitable examples of non-woven materials include, but are not limited to, fibrous sheet, melt blown, coform, air-laid, spun bond, wet laid, bonded-carded web, hydroentagled, and the like. The substrate may include wood pulp, synthetic fibers, e.g., polyester, rayon, nylon, polypropylene, polyethylene, cellulose polymers, cotton, polyurethane foams, and combinations thereof. The substrate may include a composite of various materials. In one embodiment, the substrate is nonwoven and includes a spunlace composite including polypropylene and wood pulp. In this embodiment, the composite includes polypropylene in an amount of from 30% to 40% by weight based on the total weight of the substrate and wood pulp in an amount of from 60% to 70% by weight based on the total weight of the substrate. In one embodiment, the substrate has a basis weight of from 40 to 70, alternatively from 40 to 60, and alternatively from 54 to 60 grams per square meter. Typically, the composition is loaded onto the substrate in a weight ratio of from 1:1 to 4:1 and alternatively from 2.5:1.to 3.5:1.

Typically, the composition is combined with the substrate to form the article. The article is particularly suitable for use as a cleaning wipe. However, it should be understood that the article is not limited to only this application.

The following examples are meant to illustrate the invention and are not to be viewed in any way as limiting to the scope of the invention.

### EXAMPLES

Inventive Compositions 1-8 and Comparative Composition 1 are prepared including the components set forth in Table 1 below, with all amounts listed as percent by weight based on the total weight of the respective Inventive and Comparative Composition.

TABLE 1

| | Inv. | Inv. | Inv. | Inv. | Inv. |
|---|---|---|---|---|---|
| Component | Ex. 1 | Ex. 2 | Ex. 3 | Ex. 4 | Ex. 5 |
| Biocide | 0.5 | 0.5 | 0.5 | 0.5 | 0.5 |
| First Alcohol | 0.5 | 0.5 | 0.25 | 0.25 | 0.5 |
| Alkoxylate | | | | | |
| Alkyl Polyglycoside | 0.81 | 0.85 | 0.75 | 0.75 | 0.75 |
| Carboxylated Alcohol | 0 | 0.25 | 0.25 | 0.25 | 0.25 |
| Alkoxylate | | | | | |
| First Supplemental | 0 | 0.25 | 0.25 | 0 | 0 |
| Alcohol Alkoxylate | | | | | |
| Second Supplemental | 0.28 | 0 | 0.28 | 0.28 | 0 |
| Alcohol Alkoxylate | | | | | |
| Third Supplemental | 0 | 0 | 0.5 | 0 | 0.5 |
| Alcohol Alkoxylate | | | | | |
| Fourth Supplemental | 0 | 0 | 0 | 0.25 | 0.25 |
| Alcohol Alkoxylate | | | | | |
| Water | 97.91 | 97.65 | 97.22 | 97.72 | 97.25 |
| Total | 100 | 100 | 100 | 100 | 100 |

| | Inv. | Inv. | Inv. | Comp. |
|---|---|---|---|---|
| Component | Ex. 6 | Ex. 7 | Ex. 8 | Ex. 1 |
| Biocide | 0.5 | 0.5 | 0.5 | 0.5 |
| First Alcohol | 0.25 | 0.5 | 0.25 | 0.5 |
| Alkoxylate | | | | |
| Alkyl Polyglycoside | 0.87 | 0.75 | 0.75 | 0.75 |
| Carboxylated Alcohol | 0 | 0 | 0 | 0 |
| Alkoxylate | | | | |
| First Supplemental | 0.28 | 0.25 | 0 | 0 |
| Alcohol Alkoxylate | | | | |
| Second Supplemental | 0 | 0.25 | 0 | 0 |
| Alcohol Alkoxylate | | | | |
| Third Supplemental | 0 | 0.5 | 0.5 | 0 |
| Alcohol Alkoxylate | | | | |
| Fourth Supplemental | 0.25 | 0.25 | 0 | 0 |
| Alcohol Alkoxylate | | | | |
| Water | 97.85 | 97 | 98 | 98.25 |
| Total | 100 | 100 | 100 | 100 |

Biocide is Protectol ® PE, commercially available from BASF Corporation.
First Alcohol Alkoxylate is Lutensol ® TDA 9, commercially available from BASF Corporation.
Alkyl Polyglycoside is Glucopon ® 425N, commercially available from BASF Corporation.
Carboxylated Alcohol Alkoxylate is Plurafac ® CS-1, commercially available from BASF Corporation.
First Supplemental Alcohol Alkoxylate is Lutensol ® XL 70, commercially available from BASF Corporation.
Second Supplemental Alcohol Alkoxylate is Emulan ® HE 50, commercially available from BASF Corporation.
Third Supplemental Alcohol Alkoxylate is Plurafac ® LF-1200, commercially available from BASF Corporation.
Fourth Supplemental Alcohol Alkoxylate is Plurafac ® RA30, commercially available from BASF Corporation.

The compositions are prepared by first weighing the appropriate amount of each component to be used for purposes of preparing the compositions and combining the components in a vessel. The contents of the vessel are then mixed for 30 minutes at 25° C.

For cleaning percent testing purposes, Inventive Compositions 1-8 and Comparative Composition 1 are loaded onto a nonwoven substrate comprising a spunlace composite containing from 30% to 40% polypropylene with the remaining balance wood pulp. The substrate has a weight of from 54 to 60 grams per square meter. The compositions are loaded onto the nonwoven substrate in a ratio of 3:1.

### Cleaning

Percent cleaning of the compositions is determined in accordance with the Federal Test method Std. No. 536A/GEN, “Soap and Soap-Products (Including Synthetic Detergent)”. After completing a cleaning cycle, the percent cleaning of the sample is evaluated and recorded in Table 2 below.

TABLE 2

| Example | % Cleaning |
|---|---|
| Inv. Ex. 1 | 45.7 |
| Inv. Ex. 2 | 38.21 |
| Inv. Ex. 3 | 50.01 |
| Inv. Ex. 4 | 34.73 |
| Inv. Ex. 5 | 40.45 |
| Inv. Ex. 6 | 44.25 |
| Inv. Ex. 7 | 39.36 |
| Inv. Ex. 8 | 53.29 |
| Comp. Ex. 1 | 27.13 |
| Comp. Ex. 2 | 45.61 |
| Comp. Ex. 3 | 33.09 |
| Comp. Ex. 4 | 2.35 |

Comparative Example 2 is Clorox ® Disinfecting Wipes.
Comparative Example 3 is Pledge ® Multisurface Wipes.
Comparative Example 4 is Meijer ® Surface and Glass Wipes.

As shown in Table 2 above, Inventive Examples 1-8 exhibit superior cleaning performance as compared to Comparative Examples 1, 3, and 4. Inventive Examples 1-8 exhibit comparable, and in some instances superior, cleaning performance as compared to Comparative Example 2. Notably, Comparative Examples 2-4 are industry benchmark cleaning compositions including Clorox® Disinfecting Wipes, Pledge® Multisurface Wipes, and Meijer® Surface and Glass Wipes.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, it is to be appreciated that different, special, and/or unexpected results may be obtained from each member of the respective Markush group independent from all other Markush members. Each member of a Markush group may be relied upon individually and or in combination and provides adequate support for specific embodiments within the scope of the appended claims.

It is also to be understood that any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The present invention has been described in an illustrative manner, and it is to be understood that the terminology which has been used is intended to be in the nature of words of description rather than of limitation. Obviously, many modifications and variations of the present invention are possible in light of the above teachings. It is, therefore, to be understood that within the scope of the appended claims, the present invention may be practiced otherwise than as specifically described.

What is claimed is:

1. A composition for cleaning a surface, said composition comprising:
a biocide present in an amount of greater than 0% and less than 2% by weight based on the total weight of said composition;
a first alcohol alkoxylate present in an amount of greater than 0% and less than 2% by weight based on the total weight of said composition and having the general formula (II):
R¹—O-(A)_{b}H, (II)
wherein R¹ is a hydrocarbon group having from 10 to 20 carbon atoms, each A is independently selected from alkyleneoxy groups having from 2 to 4 carbon atoms, and b has a value of from 5 to 15;
an alkyl polyglycoside present in an amount of greater than 0% and less than 2% by weight based on the total weight of said composition;
a supplemental alcohol alkoxylate present in amount of greater than 0% and less than 2% by weight based on the total weight of said composition; and
water present in an amount of at least 92% and less than 100% by weight based on the total weight of said composition;
wherein said composition is substantially free of volatile organic compounds and has a cleaning performance of from 30% to 70% as determined in accordance with the Federal Test method Std. No. 536A/GEN, “Soap and Soap-Products (Including Synthetic Detergent)”.

2. A composition as set forth in claim 1 wherein said composition has a cleaning performance of from 45% to 55% as determined in accordance with the Federal Test method Std. No. 536A/GEN, “Soap and Soap-Products (Including Synthetic Detergent)”.

3. A composition as set forth in claim 1 wherein said biocide is present in an amount of from 0.4% to 0.6% by weight based on the total weight of said composition.

4. A composition as set forth in claim 1 wherein said first alcohol alkoxylate is present in an amount of from 0.2% to 0.6% by weight based on the total weight of said composition.

5. A composition as set forth in claim 1 wherein an alkyl polyglycoside is present in an amount of from 0.7% to 0.9% by weight based on the total weight of said composition.

6. A composition as set forth in claim 1 wherein R is a straight chain hydrocarbon group having 13 carbon atoms, A is an ethyleneoxy group, and b has a value of from 8 to 10.

7. A composition as set forth in claim 1 wherein said biocide has the general formula (I): 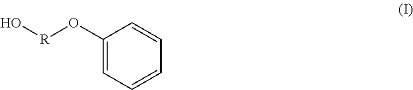
wherein R is a hydrocarbon group having from 1 to 4 carbon atoms.

8. A composition as set forth in claim 1 wherein said alkyl polyglycoside has the general formula (III):
(D)-OR² (III)
wherein D is a glycosyl group and has a degree of polymerization of from 1 to about 3 and R² is a hydrocarbon group having from 8 to 16 carbon atoms.

9. A composition as set forth in claim 1 wherein said supplemental alcohol alkoxylate includes a carboxylated alcohol alkoxylate.

10. A composition as set forth in claim 9 wherein said carboxylated alcohol alkoxylate has the general formula (IV): 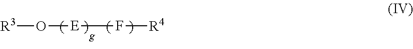
wherein R³ is hydrocarbon group having from 6 to 14 carbon atoms; R⁴ is selected from the group of a hydrogen atom, an alkyl group, and an aryl group; each E is independently selected from alkyleneoxy groups having from 2 to 4 carbon atoms; g has a value of from 12 to 25; and F is of the general formula (V): 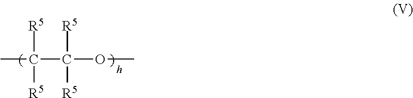
wherein each R⁵ is independently selected from the group of a hydrogen atom, a methyl group, and a salt of a carboxyl group so long as at least one R⁵ is a salt of a carboxyl group; and h has a value of from 13 to 20.

11. A composition as set forth in claim 10 wherein said carboxyl group is further defined as a dicarboxyl group.

12. A composition as set forth in claim 10 wherein said carboxylated alcohol alkoxylate is of the general formula (VI): 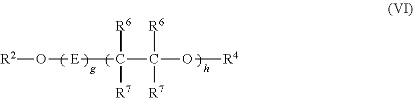
wherein R³, R⁴, E, g, and h are the same as claimed above; each R⁶ is independently selected from the group of a hydrogen atom and a methyl group; and each R⁷ is independently selected from the group of a hydrogen atom and a salt of a dicarboxyl group of the general formula (VII): 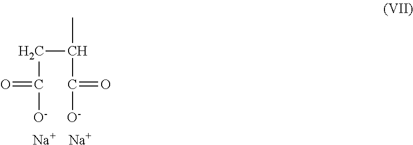
wherein at least one R⁷ is represented by said salt of said dicarboxyl group of the general formula (VII).

13. A composition as set forth in claim 10 wherein g has a value of from 15 to 19 and h has a value of from 15 to 19.

14. A composition as set forth in claim 9 wherein said supplemental alcohol alkoxylate further includes at least one of a first supplemental alcohol alkoxylate, a second supplemental alcohol alkoxylate, a third supplemental alcohol alkoxylate, a fourth supplemental alcohol alkoxylate, and combinations thereof.

15. A composition as set forth in claim 1 wherein said supplemental alcohol alkoxylate includes a first supplemental alcohol alkoxylate.

16. A composition as set forth in claim 15 wherein said first supplemental alcohol alkoxylate has the general formula (VIII):
R⁸—O—(I)ⱼH (VIII)
wherein R⁸ is a hydrocarbon group having from 6 to 14 carbon atoms; each I is independently selected from alkyleneoxy groups having from 2 to 4 carbon atoms; and j has a value of from 3 to 20.

17. A composition as set forth in claim 15 wherein said supplemental alcohol alkoxylate further includes at least one of a second supplemental alcohol alkoxylate, a third supplemental alcohol alkoxylate, a fourth supplemental alcohol alkoxylate, and combinations thereof.

18. A composition as set forth in claim 1 wherein said supplemental alcohol alkoxylate includes a second supplemental alcohol alkoxylate.

19. A composition as set forth in claim 18 wherein said second supplemental alcohol alkoxylate has the general formula (XI):
R⁹—O—(K)₁H (XI)
wherein R⁹ is a hydrocarbon group having from 2 to 10 carbon atoms; each K is independently selected from alkyleneoxy groups having from 2 to 4 carbon atoms; and 1 has a value of from 2 to 10.

20. A composition as set forth in claim 18 wherein said supplemental alcohol alkoxylate further includes at least one of a third supplemental alcohol alkoxylate, a fourth supplemental alcohol alkoxylate, and combinations thereof.

21. A composition as set forth in claim 1 wherein said supplemental alcohol alkoxylate includes a third supplemental alcohol alkoxylate.

22. A composition as set forth in claim 21 wherein said third supplemental alcohol alkoxylate has the general formula (X):
R¹⁰—O-(M)ₙH (X)
wherein R¹⁰ is a hydrocarbon group having from 5 to 30 carbon atoms; each M is independently selected from alkyleneoxy groups having from 2 to 4 carbon atoms; and n has a value of from 1 to 10.

23. A composition as set forth in claim 21 wherein said supplemental alcohol alkoxylate further includes a fourth supplemental alcohol alkoxylate.

24. A composition as set forth in claim 1 wherein said supplemental alcohol alkoxylate includes a fourth supplemental alcohol alkoxylate.

25. A composition as set forth in claim 24 wherein said fourth supplemental alcohol alkoxylate has the general formula (XI):
R¹¹—O—(P)_{q}H (XI)
wherein R¹¹ is a hydrocarbon group having from 5 to 20 carbon atoms; each P is independently selected from alkyleneoxy groups having from 2 to 4 carbon atoms; and q has a value of from 2 to 18.

26. An article for cleaning a surface, said article comprising:
a substrate; and
a composition comprising:
a biocide present in an amount of greater than 0% and less than 2% by weight based on the total weight of said composition;
a first alcohol alkoxylate present in an amount of greater than 0% and less than 2% by weight based on the total weight of said composition and having the general formula (II):
R—O-(A)_{b}H (II)
wherein R is a hydrocarbon group having from 10 to 20 carbon atoms, each A is independently selected from alkyleneoxy groups having from 2 to 4 carbon atoms, and b has a value of from 5 to 15;
an alkyl polyglycoside present in an amount of greater than 0% and less than 2% by weight based on the total weight of said composition;
a supplemental alcohol alkoxylate present in amount of greater than 0% and less than 2% by weight based on the total weight of said composition; and
water present in an amount of at least 92% and less than 100% by weight based on the total weight of said composition; and
wherein said composition is substantially free of volatile organic compounds and has a cleaning performance of from 30% to 70% as determined in accordance with the Federal Test method Std. No. 536A/GEN, “Soap and Soap-Products (Including Synthetic Detergent)”.

27. An article as set forth in claim 26 wherein said substrate comprises a nonwoven spunlace composite comprising:
polypropylene in an amount of from 30% to 40% by weight based on the total weight of said substrate; and
wood pulp in an amount of from 60% to 70% by weight based on the total weight of said substrate.
